(19) United States
(12) Patent Application Publication
(10) Pub. No.: US 2011/0153678 A1
(43) Pub. Date: Jun. 23, 2011

(54) CONFIGURATION INFORMATION MANAGEMENT SYSTEM, CONFIGURATION INFORMATION MANAGEMENT METHOD, AND DISTRIBUTED INFORMATION MANAGEMENT DEVICE

(75) Inventors: Masazumi Matsubara, Kawasaki (JP); Hiroshi Otsuka, Kawasaki (JP); Yuji Wada, Kawasaki (JP); Yasuhide Matsumoto, Kawasaki (JP)

(73) Assignee: FUJITSU LIMITED, Kawasaki-shi (JP)

(21) Appl. No.: 12/972,854

(22) Filed: Dec. 20, 2010

(30) Foreign Application Priority Data
Dec. 22, 2009 (JP) 2009-291020

(51) Int. Cl. G06F 17/30

(52) U.S. Cl. 707/802; 707/E17.005

(57) ABSTRACT

A system includes FCMDBs managing IPROP among attribute information from MDRs managing the attribute information of each configuration type regarding a CI. The DCMDB includes a determining unit that, when a CI registration request is detected, determines whether multiple types of IPROP are contained in the request; an entity ID collector that, when the request contains multiple types, collects, from each FCMDB, an entity ID of the IPROP and an entity ID of other registered IPROP; an adding unit that, when all types of entity IDs of the same CI are collected, adds a common entity ID of the same CI to all types of IPROP regarding the same CI; and a reconciliation register that distributes the data obtained by federating all types of entity data regarding the same CI to the DCMDBs that relate to the common entity ID and registers the federated data in the DCMDBs.

### CROSS-REFERENCE TO RELATED APPLICATION

This application is based upon and claims the benefit of priority of the prior Japanese Patent Application No. 2009-291020, filed on Dec. 22, 2009, the entire contents of which are incorporated herein by reference.

### FIELD

The embodiments discussed herein are directed to a configuration information management system, a configuration information management method, and a distributed information management device.

### BACKGROUND

Development of open and multi-vendor IT systems is becoming large-scale and complicated with increases in the number of servers and in storage capacity. Accordingly, operation costs increase and the system stops and lower service quality due to human-induced errors are becoming a big problem. To solve such problems, management of configuration information in IT systems, such as servers, storage, and applications, is becoming important.

As devices that manage configuration information of an IT system, a database called a configuration management database is well known. A configuration management database corresponds to a database of operation-management middleware that manages the operation-management data of the IT system.

For example, for operations of a data center, there is operation-management middleware that is optimized for management operations, such as server management, network management, service management, and asset management. Each type of operation-management middleware includes a unique configuration management database and registers configuration information regarding each operation in the configuration-management database. As described above, each configuration-management database manages configuration information independently with respect to other configuration management databases. For this reason, the method of accessing a configuration-management database and the data format of configuration information that is managed by each configuration-management database may differ depending on each configuration-management database; therefore, human operations are required for coordination between configuration management databases.

To reduce human operations, configuration information management devices have been developed that include a database called a federated configuration management database (FCMDB) that virtually federates various types of configuration information that exists in multiple configuration management databases. In an FCMDB, each configuration management database whose data is virtually federated is called a management data repository (MDR). FIG. 12 is an explanatory view of a configuration of an FCMDB system 100. The FCMDB system 100 illustrated in FIG. 12 includes a plurality of MDRs 101, an FCMDB 102, and a client terminal 104. The FCMDB system 100 establishes communication connections between the MDRs 101 and the FCMDB 102 via a network 103.

Each MDR 101 manages attribute information of each configuration type regarding the configuration of, for example, a device in an IT system. Furthermore, each MDR 101 manages data of a different configuration type and a different amount of data. In addition, each MDR 101 manages various types of information, such as attribute information, in association with its own local ID. For example, an MDR 101A manages design information, an MDR 101B manages product information, an MDR 101C manages performance information, and an MDR 101D manages configuration information.

The FCMDB 102 federates and manages configuration information regarding the same object, which is information that is distributed to the MDRs 101 and managed. Specifically, the FCMDB 102 manages configuration items (CI), such as devices, software, and data logs, and relationships (R) between the CIs. For example, the CI “C” that is managed by the FCMDB 102 is federated configuration information: design information C″ that is managed by the MDR 101A, performance information Ĉ that is managed by the MDR 101C, and configuration information C′ that is managed by the MDR 101D.

An operator, such as a system manager, can manage and understand easily the entire configuration of the IT system with reference to configuration information that is virtually federated using the FCMDB 102 under various circumstances regarding system operations, such as batch application operations or hardware protection operations.

FIG. 13 is an explanatory diagram illustrating the principle of data federation by the FCMDB system 100. In the example illustrated in FIG. 13, the MDR 101A manages “Server”, “ID: WebServer1”, and “S/N:XYZ123” as attribute information regarding the same CI. The MDR 101B manages “Server”, “ID:192.168.0.1”, and “Product number:XYZ123” as attribute information regarding the same CI. The MDR 101C manages “Host”, “ID:hostnameX”, and “SERNO:XYZ123” as attribute information regarding the same CI. The MDR 101D manages “Node”, “ID:192.168.0.1”, and “SN:XYZ123” as attribute information regarding the same CI. In other words, although each MDR 101 manages attribute information regarding the same CI, each MDR 101 manages attribute information of a different configuration type.

Thus, the FCMDB 102 converts the attribute information regarding the same CI, which is information managed by each MDR 101, to a common format. The FCMDB 102 further performs a reconciliation process for identifying a CI using, as a key, the common property having a unique attribute value according to the attribute information. The attribute information is managed according to the local ID that is different with respect to each MDR 101. The common property is, for example, the product number XYZ123 in the following: “S/N:XYZ123”, “Product number:XYZ123”, “SERNO:XYZ123”, and “SN:XYZ123”.

According to the attribute information, which is managed using the local ID that is different with respect to each MDR 101, the FCMDB 102 identifies the CI using, as a key, the common property representing the production number. The FCMDB 102 federates the attribute information regarding the same CI that is distributed to and managed in the MDRs 101 and manages the federated attribute information.

In recent years, distribution FCMDB systems that include the FCMDB 102 in order to significantly increase the system processing performance are well known. FIG. 14 is an explanatory diagram of a configuration of a distributed FCMDB system 100A.

The distributed FCMDB system 100A illustrated in FIG. 14 includes a plurality of MDRs 101, a plurality of FCMDBs 102, and a plurality of client terminals 104. Communication connections are established between the FCMDBs 102 via a network 103.

Furthermore, the distributed FCMDB system 100A distributes data to the FCMDBs 102, using a distribution hash table technology, and manages the data by each CI/R.

For example, when the data of the graph-structured CI₁-R₁-CI₂-R₂-CI₃ is distributed to the FCMDBs 102 and managed, the data CI₁ is managed in an FCMDB 102E and the data R₁-CI₂ is managed in an FCMDB 102F. Furthermore, the data R₂ is managed in an FCMDB 102B and the data CI₃ is managed in an FCMDB 102C.

Accordingly, in the distributed FCMDB system 100A, the graph-structured data is distributed to the FCMDBs 102 and is managed by each CI/R. Thus, the process load on each FCMDB 102 can be reduced over the system.

Patent Document: Japanese Laid-open Patent Publication No. 2007-243248

Non-patent Literature: Configuration Management Database (CMDB) Federation Specification Version 1.0.0″, DMTF, Retrieved on Jun. 22, 2009 from http://www.dmtf.org/standards/published_documents/DSP0252_{—}1.0.0.pdf

In the conventional distributed FCMDB system 100A, data is distributed to the FCMDBs 102 and is managed by each CI/R. However, because, when registering CI/R, it is necessary to check that the same CI/R is not already registered, the information necessary for reconciling the CIs or Rs (reconciliation information) is centrally managed in a single specific FCMDB 102A. Assuming that the specific FCMDB is the FCMDB 102A, the load is concentrated on the FCMDB 102A and thus the process load on the FCMDB 102A increases. Furthermore, a large-scale storage capacity is required for storage in the FCMDB 102A.

### SUMMARY

According to an aspect of an embodiment of the invention, a configuration information management system includes a plurality of distributed information management devices that distribute and manage predetermined attribute types of common attribute information among attribute information of each configuration type regarding a configuration item, which is to be managed, from a plurality of configuration information control devices that manage the attribute information, the common attribute information being used to identify the configuration item. The distributed information management device includes an identification information collector that collects identification information corresponding to the predetermined attribute types of common attribute information regarding the same configuration item; a common identification information adding unit that, when the identification information corresponding to the predetermined attribute types of common attribute information regarding the same configuration item is collected, adds common identification information corresponding to the same configuration item to each of the predetermined attribute types of common attribute information regarding the same configuration item; and a common attribute information manager that manages each of the predetermined types of common attribute information regarding the same configuration item in association with the common identification information that is added by the common identification information adding unit.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a block diagram of a configuration of a configuration information management system according to a first embodiment of the present invention;

FIG. 2 is a block diagram of a configuration of a distributed FCMDB system according to a second embodiment of the present invention;

FIG. 3 is a block diagram of a configuration of an FCMDB;

FIG. 4 is an explanatory view of the table contents of an entity management table;

FIG. 5 is an explanatory view illustrating the basic principle of a data storage FCMDB search unit;

FIG. 6 is an explanatory view illustrating the basic principle of the data storage FCMDB search unit;

FIG. 7 is an explanatory view of an example of process contents of a reconciliation process of the FCMDB;

FIG. 8 is a flowchart of process operations involving a data registration process of the distributed FCMDB system;

FIG. 9 is a flowchart of process operations involving the data registration process of the distributed FCMDB system;

FIG. 10 is a flowchart of process operations involving an identification rule change process of the distributed FCMDB system;

FIG. 11 is a diagram of a computer that executes a distributed information management program;

FIG. 12 is an explanatory view of a configuration of an FCMDB system;

FIG. 13 is an explanatory view illustrating a basic principle of data federation of the FCMDB system; and

FIG. 14 is an explanatory view of a configuration of a distributed FCMDB system.

### DESCRIPTION OF EMBODIMENTS

Preferred embodiments of the present invention will be explained with reference to accompanying drawings. The contents of the embodiments do not limit the technical idea of the present invention.

### [a] First Embodiment

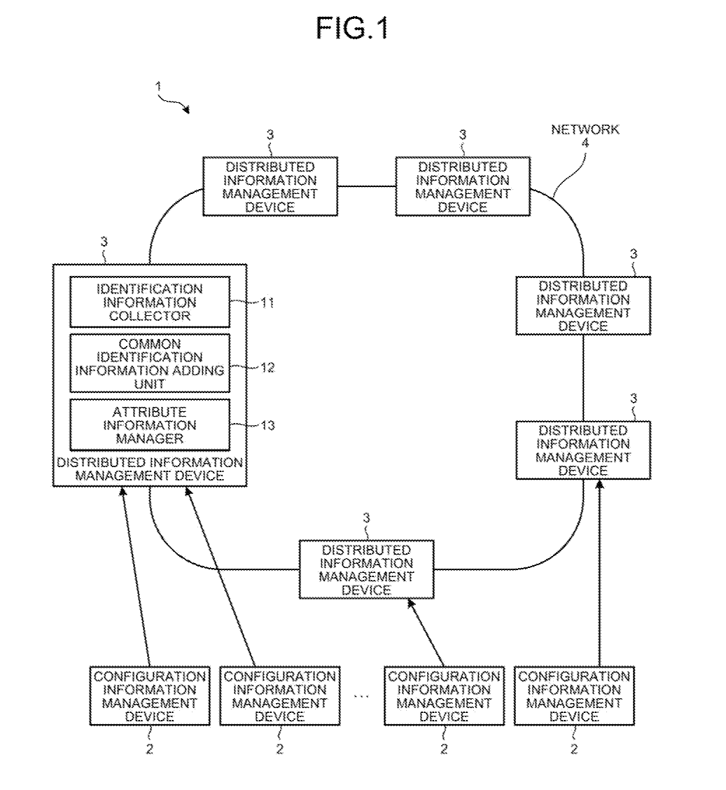

FIG. 1 is a block diagram of a configuration of a configuration information management system 1 according to a first embodiment of the present invention. The configuration information management system 1 illustrated in FIG. 1 includes a plurality of configuration information management devices 2 and a plurality of distributed information management devices 3. The configuration information management devices 2 manage attribute information of each configuration type regarding a configuration item to be managed. Multiple predetermined attribute types of common attribute information, which are used to identify the configuration item, among the attribute information from the configuration information management devices 2 are distributed to and managed by the distributed information management devices 3. Communication connections are established between the distributed information management devices 3 via a network 4. The distributed information management device 3 includes an identification information collector 11, a common identification information adding unit 12, and an attribute information manager 13.

The identification information collector 11 collects identification information corresponding to the predetermined attribute types of common attribute information regarding the same configuration item. When identification information corresponding to the predetermined attribute types of common attribute information regarding the same configuration item is collected, the common identification information adding unit 12 adds common identification information, which corresponds to the same configuration item, to each of the predetermined attribute types of common attribute information regarding the same configuration item. Furthermore, the attribute information manager 13 manages each of the predetermined attribute types of common attribute information regarding the same configuration item in association with the common identification information that is added by the common identification information adding unit 12.

In the first embodiment, when identification information corresponding to predetermined attribute types of common attribute information regarding the same configuration item is collected, common identification information corresponding to the same configuration item is added to each of the predetermined attribute types of common attribute information regarding the same configuration item. Furthermore, in the first embodiment, each of the predetermined attribute types of common identification information regarding the same configuration item is managed in association with the common identification information. Because the common identification information corresponding to the same configuration item is added to each type of common attribute information, even if the common attribute information regarding the same configuration item is distributed, each distributed information management device 3 can identify the configuration item according to the common identification information.

Furthermore, in the first embodiment, by distributing and managing the common attribute information regarding a configuration item, the configuration item can be quickly identified using the common attribute information while reducing the process load on the distributed information management device without it being necessary to increase the storage capacity.

### [b] Second Embodiment

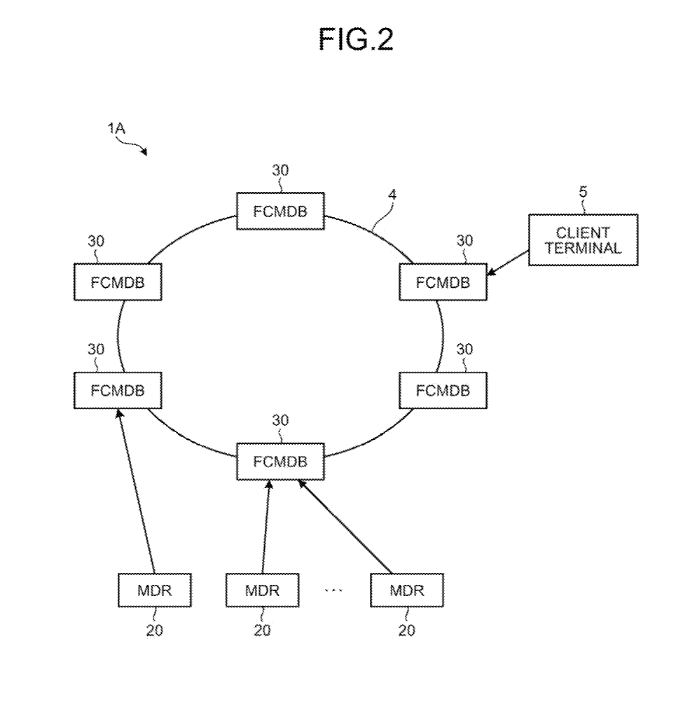

FIG. 2 is a block diagram of a configuration of a distributed FCMDB system 1A according to a second embodiment of the present invention. The distributed FCMDB system 1A illustrated in FIG. 2 includes different types of configuration management data repositories (MDR) 20, federated configuration management databases (FCMDB) 30, and a client terminal 5. Communication connections are established between the FCMDBs 30 via the network 4.

The MDR 20 manages attribute information of each configuration type regarding a configuration item that constitutes configuration information of an object to be managed, i.e., regarding a configuration item (CI), such as a server, storage, or software, that constitutes the IT system. A configuration type is, for example, design information, product information, performance information, and configuration information. The attribute information contains an attribute name and an attribute value. The attribute name corresponds to, for example, an IP address name, a serial number, or a domain name. The attribute value corresponds to, for example, an IP address value, a serial number value, or a domain name. Each MDR 20 manages data of a different configuration type and a different amount of data and manages attribute information in association with its own local ID.

The FCMDBs 30 virtually federate data in the MDRs 20 and reconcile and federate the data by each CI/R, and the FCMDBs 30 distribute and manage the data. The FCMDB 30 manages identifying property (IPROP) data among the attribute information in the CI. The IPROP data corresponds to common attribute information for identifying the CI among multiple types of attribute information in the CI, which are different according to each MDR 20. The common attribute information identifies the CI using, as a key, the common property including a unique attribute value. The contents of the IPROP data correspond to predetermined common attribute information that is specified by a pre-specifying operation, i.e., corresponds to a set of predetermined attribute names and attribute values of the predetermined attribute names. Specifically, the attribute name corresponds to an IP address, a serial number, and a combination of a host name and a domain name, and the attribute values corresponds to “192.168.0.1” for the IP address and “SVR012345” for the serial number.

When the client terminal 5 issues, to the distributed FCMDB system 1A, a request for retrieving configuration information, the entity data of the CI and R of the configuration information that is distributed to and managed by the FCMDBs 30 is collected according to the retrieval request. The client terminal 5 displays collected entity data of the CI and R on the display.

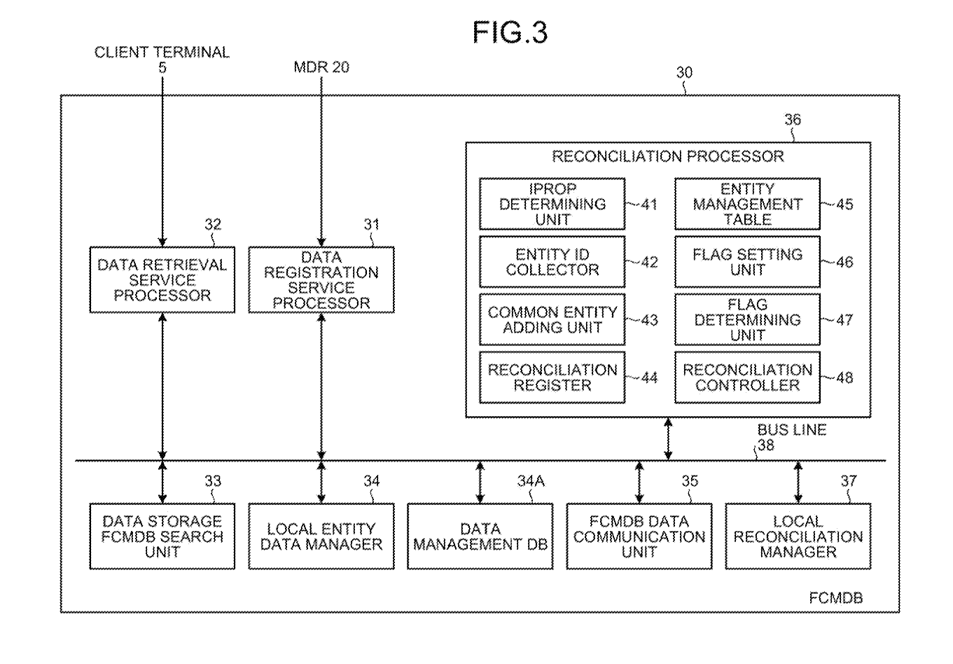

FIG. 3 is a block diagram of a configuration of the FCMDB 30. The FCMDB 30 illustrated in FIG. 3 includes a data registration service processor 31, a data retrieval service processor 32, a data storage FCMDB search unit 33, a local entity data manager 34, a data management DB 34A, and an FCMDB data communication unit 35. The FCMDB 30 further includes a reconciliation processor 36, a local reconciliation manager 37, and a bus line 38.

The data registration service processor 31 is a processor that receives, from the MDR 20, a CI/R registration request. The data retrieval service processor 32 is a processor that receives a retrieval request from the client terminal 5.

Upon detecting a registration request in the data registration service processor 31 or a retrieval request in the data retrieval service processor 32, the data storage FCMDB search unit 33 acquires the FCMDB 30 in which the data is stored, using the distribution hash table technology. The data storage FCMDB search unit 33 computes CI/R or the IPROP data in the registration request or the retrieval request and calculates a hash value using a hash function. According to the calculated hash value, the data storage FCMDB search unit 33 acquires the FCMDB 30 in which the entity data of, for example, the CI/R or the IPROP data is stored.

The local entity data manager 34 registers the entity data by each CI/R, which is managed by the local entity data manager 34, in association with the entity ID in the data management DB 34A and manages the entity data in the data management DB 34A. The FCMDB data communication unit 35 transmits data to or receives data from other FCMDBs 30. The bus line 38 corresponds to a data communication path between various types of units in the FCMDB 30.

The reconciliation processor 36 includes an IPROP determining unit 41, an entity ID collector 42, a common entity adding unit 43, a reconciliation register 44, an entity management table 45, a flag setting unit 46, a flag determining unit 47, and a reconciliation controller 48.

When a CI registration request is detected, the IPROP determining unit 41 determines whether IPROP data is in the registration request. When the IPROP determining unit 41 determines that IPROP data is in the registration request, the entity ID collector 42 collects the entity IDs of the IPROP data from the entity management table 45 of each FCMDB 30. Furthermore, the entity ID collector 42 collects the entity IDs associated with another type of IPROP data that is contained in the same registration request from the entity management table 45 of each FCMDB 30. For example, it is assumed that there are three types of IPROP data: the IP address, the serial number, and a combination of the host name and the domain name. It is further assumed that the registration request contains IPROP data: the IP address and the serial number. In this case, another type of IPROP data that is contained in the same registration request corresponds to the combination of the host name and the domain name of the CI. In other words, the entity ID collector 42 recognizes that it is the same CI even if only one of the three types of IPROP data, which are specified as identification conditions, matches.

When IPROP data is in the registration request, the entity ID collector 42 extracts the attribute name and the attribute value of the IPROP data. The entity ID collector 42 computes the attribute name and the attribute value of the IPROP data and calculates a hash value of the IPROP data via the data storage FCMDB search unit 33 using a hash function. According to the hash value of the IPROP data, the entity ID collector 42 acquires the FCMDB 30 in which the IPROP data is stored. The entity ID collector 42 issues, to the FCMDB 30, which is in charge of and manages the IPROP data, about the entity ID corresponding to the IPROP data that is already registered in the entity management table 45.

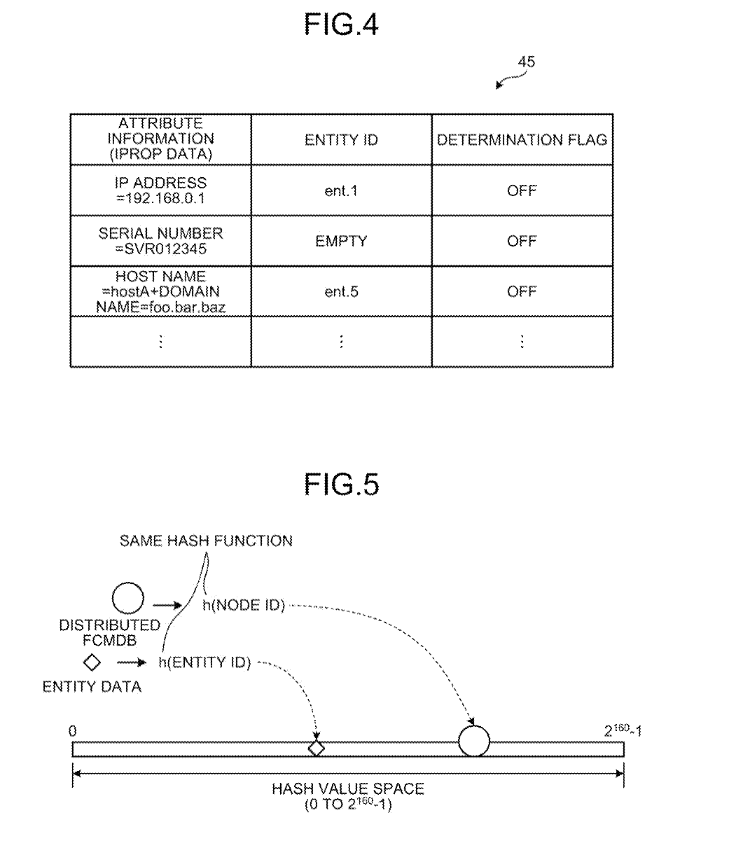

FIG. 4 is an explanatory view of the table contents of the entity management table 45. The entity management table 45 registers and manages an entity ID and a determination flag of each type of IPROP data (an attribute name and an attribute value) that the FCMDB 30 is in charge of and manages. For example, when the attribute name is “IP address” and the attribute value is “192.168.0.1”, the IPROP data “IP address=192.168.0.1”, the entity ID “ent.1”, and the determination flag are managed in association with one another.

The entity ID collector 42 successively acquires the entity IDs of the IPROP data from the FCMDB 30 that is in charge of and manages each type of IPROP data in the registration request.

When the entity IDs corresponding to the IPROP data regarding the same Clare acquired via the entity ID collector 42, the common entity adding unit 43 selects one entity ID from the acquired entity IDs using a predetermined selection algorithm. The common entity adding unit 43 then determines the entity ID, which is selected using the predetermined selection algorithm, as a common entity ID of the IPROP data regarding the same CI. The predetermined selection algorithm selects an entity ID according to the order in which the IPROP data is specified and registered or according to the ascending order.

When the common entity adding unit 43 determines the common entity ID, the common entity adding unit 43 requests the FCMDB 30, which is in charge of and manages the IPROP data, to rewrite the entity IDs in the entity management table 45, which are IDs corresponding to the IPROP data regarding the same CI, to the common entity ID. Accordingly, each FCMDB 30 changes, to the common entity ID, the entity IDs of the IPROP data regarding the same CI that are already registered in the entity management table 45.

The reconciliation register 44 computes the common entity ID and calculates the hash value of the common entity ID via the data storage FCMDB search unit 33 using a hash function. Furthermore, according to the hash value of the common entity ID, the reconciliation register

44 calculates the FCMDB 30 that federates and manages all entity data regarding the same CI (hereinafter, “federation-management FCMDB 30”). Furthermore, the reconciliation register 44 notifies the federation-management FCMDB 30 of a data federation request. Upon detecting the data federation request that contains the common entity ID, the reconciliation register 44 in the federation-management FCMDB 30 collects the entity data regarding the same CI from the FCMDB 30 that is in charge of and manages the entity data regarding the same CI. When all the types of entity data regarding the same Clare collected, the reconciliation register 44 in the federation-management FCMDB 30 federates all the types of entity data and registers the federated all the types of entity data in association with the common entity ID in the local entity data manager 34.

Upon receiving a notification that the entity ID corresponding to the IPROP data in the entity management table 45 is determined, the flag setting unit 46 that is in charge of the entity management table 45 turns on the determination flag corresponding to the IPROP data.

When the IPROP determining unit 41 determines that IPROP data is in the registration request, the flag determining unit 47 determines whether the determination flag corresponding to the IPROP data is turned on in the FCMDB 30 that is in charge of and manages the IPROP data.

When the determination flag corresponding to the IPROP data is turned off, the reconciliation controller 48 starts the collection operation of the entity ID collector 42 for collecting entity IDs corresponding to another type of IPROP data regarding the same CI including the IPROP data in the registration request.

In contrast, when the determination flag corresponding to the IPROP data is turned on, the reconciliation controller 48 does not perform the collecting operation of the entity ID collector 42 for collecting entity IDs with respect to the remaining IPROP data. In other words, when the determination flag is on, it is unnecessary for the FCMDB 30 to perform the hash value calculation process, the entity ID collecting process, and the common entity ID adding process of the entity ID collector 42 on the remaining IPROP data. Furthermore, it is not necessary for the FCMDB 30 to perform the process for calculating a hash value of a common entity ID and the process for federating entity data. For this reason, if all the types of IPROP data in the same CI have been determined, the FCMDB 30 can achieve more high-speed processing by skipping extra processes.

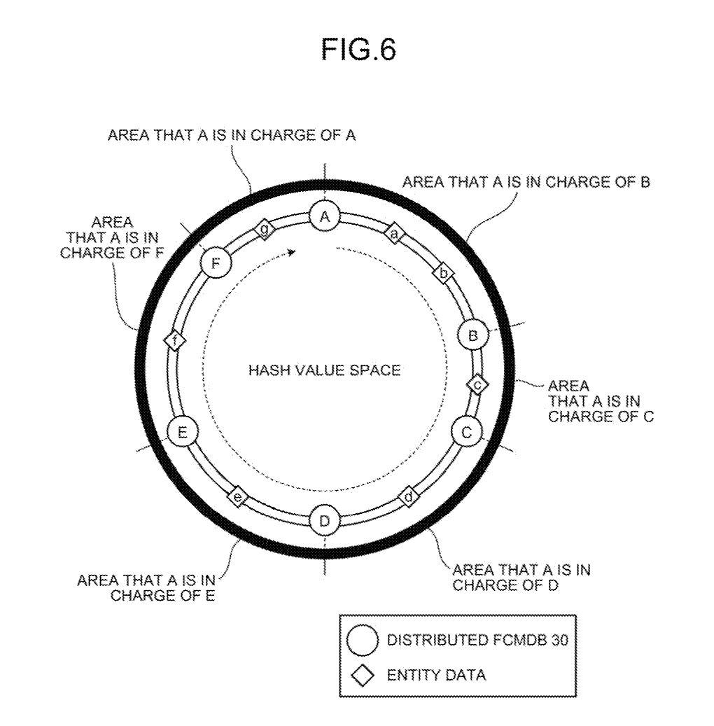

FIGS. 5 and 6 are explanatory views of the basic principle of the data storage FCMDB search unit 33. As illustrated in FIG. 5, the data storage FCMDB search unit 33 maps the FCMDBs 30 (nodes) and the entity data, which is distributed to each FCMDB 30 and managed in each FCMDB, in the same hash value space (0 to 2¹⁶⁰−1), using the same hash function. FIG. 5 also illustrates the case in which SHA-1 is used as a hash function.

As illustrated in FIG. 6, the start point and the end point of the hash value space are connected like a link, and each FCMDB 30 manages the mapped entity data between the FCMDB 30 and a clockwise previous FCMDB 30. For example, the FCMDB 30 denoted by “A” is in charge of and manages the entity data “g” between the FCMDB 30 denoted by “A” and the FCMDB 30 denoted by “F”, and the FCMDB 30 denoted by “B” is in charge of and manages the entity data “a” and “b” between the FCMDB 30 denoted by “B” and the FCMDB 30 denoted by “A”.

The data storage FCMDB search unit 33 computes the entity ID of entity data using the hash function and calculates the hash value. According to the calculated hash value, the data storage FCMDB search unit 33 acquires the FCMDB 30 that is in charge of and manages the IPROP data in the hash value space.

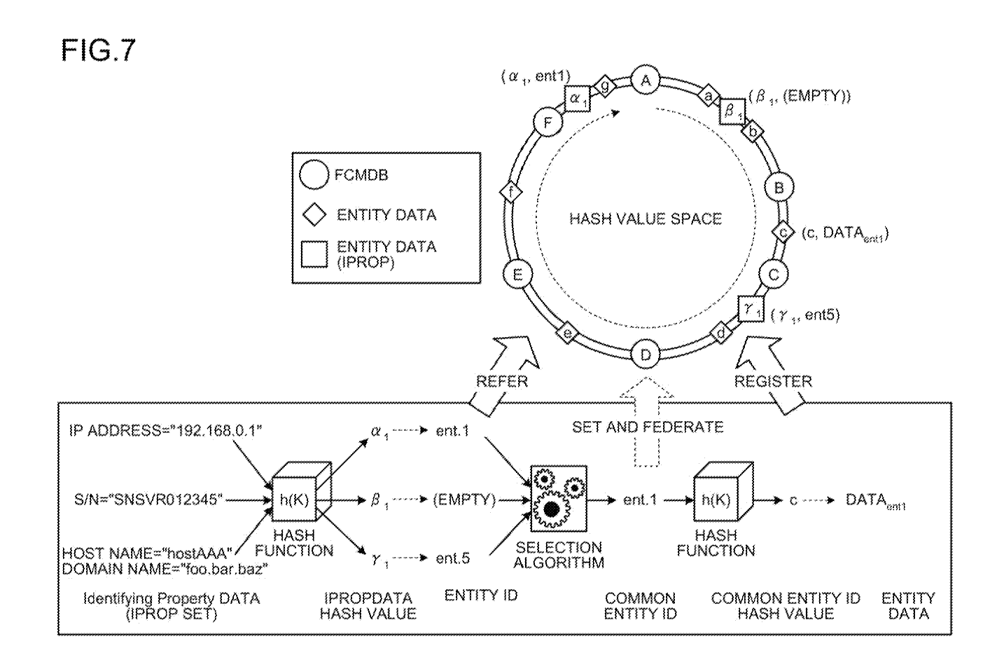

FIG. 7 is an explanatory diagram of an example of contents of a process of the reconciliation processor 36 of the FCMDB 30. It is supposed that there are three types of IPROP data: an IP address, a serial number (S/N), and a combination of a host name and a domain name. Furthermore, the attribute value of the IP address is “192.168.0.1”, the attribute value of the serial number is “SNSVR012345”, the attribute value of the host name is “hostAAA”, and the attribute value of the domain name is “foo.bar.baz”.

The entity ID collector 42 of a receiving FCMDB 30A denoted by “E” computes a hash function h with respect to each type of IPROP data (attribute name and attribute value) regarding the same CI and calculates the hash value via the data storage FCMDB search unit 33. The entity ID collector 42 calculates a hash value α1 of the IP address, a hash value β1 of the serial number, a hash value γ1 of the combination of the host name and the domain name.

According to the hash value α1 of the IP address, the entity ID collector 42 acquires the FCMDB 30 denoted by “A” that is in charge of and manages the IPROP data of the IP address. The entity ID collector 42 requests of the FCMDB 30 denoted by “A” the entity ID corresponding to the IPROP data in the entity management table 45 via the FCMDB data communication unit 35. The entity ID collector 42 then acquires “ent.1” as an entity ID corresponding to the IPROP data of the IP address.

According to the hash value β1 of the serial number, the entity ID collector 42 acquires the FCMDB 30 denoted by “B” that is in charge of and manages the IPROP data of the serial number. The entity ID collector 42 requests of the FCMDB 30 denoted by “B” the entity ID corresponding to the IPROP data in the entity management table 45 via the FCMDB data communication unit 35. However, the entity ID corresponding to the IPROP data is not registered in the entity management table 45. Thus, the entity ID collector 42 acquires “Empty” as an entity ID corresponding to the IPROP data of the serial number.

According to the hash value γ1 of the combination of the host name and the domain name, the entity ID collector 42 acquires the FCMDB 30 denoted by “D” that is in charge of and manages the IPROP data of the combination of the host name and the domain name. The entity ID collector 42 requests the FCMDB 30 denoted by “D” the entity ID corresponding to the IPROP data in the entity management table 45 via the FCMDB data communication unit 35. The entity ID collector 42 then acquires “ent.5” as an entity ID corresponding to the IPROP data of the combination of the host name and the domain name.

The common entity adding unit 43 of the receiving FCMDB 30A denoted by “E” selects one entity ID from the entity IDs corresponding to all types of IPROP data regarding the same CI, using a predetermined selection algorithm. The common entity adding unit 43 selects one entity ID “ent.1” and determines the selected entity ID as a common entity ID. The common entity adding unit 43 notifies the FCMDBs 30, which that are in charge of and manages the IPROP data, of the common entity ID via the FCMDB data communication unit 35. Each of the FCMDBs 30 rewrites the entity ID in the entity management table 45 corresponding to the IPROP data to the common entity ID and registers the common entity ID.

The reconciliation register 44 of the receiving FCMDB 30A denoted by “E” computes the common entity ID using the hash function h and calculates the hash value via the data storage FCMDB search unit 33. Furthermore, according to the hash value c of the common entity ID, the reconciliation register 44 acquires the federation-management FCMDB 30 that is denoted by “C”. The reconciliation register 44 notifies the federation-management FCMDB 30, which is denoted by “C”, of a request for federating all entity data via the FCMDB data communication unit 35. The federation-management FCMDB 30, which is denoted by “C”, federates the data regarding the same CI that is registered as ent.5. Furthermore, the federation-management FCMDB 30, which is denoted by “C”, associates the federated entity data with the common entity ID “ent.1” and registers the data as (c, DATA_{ent.1}) in the local entity data manager 34.

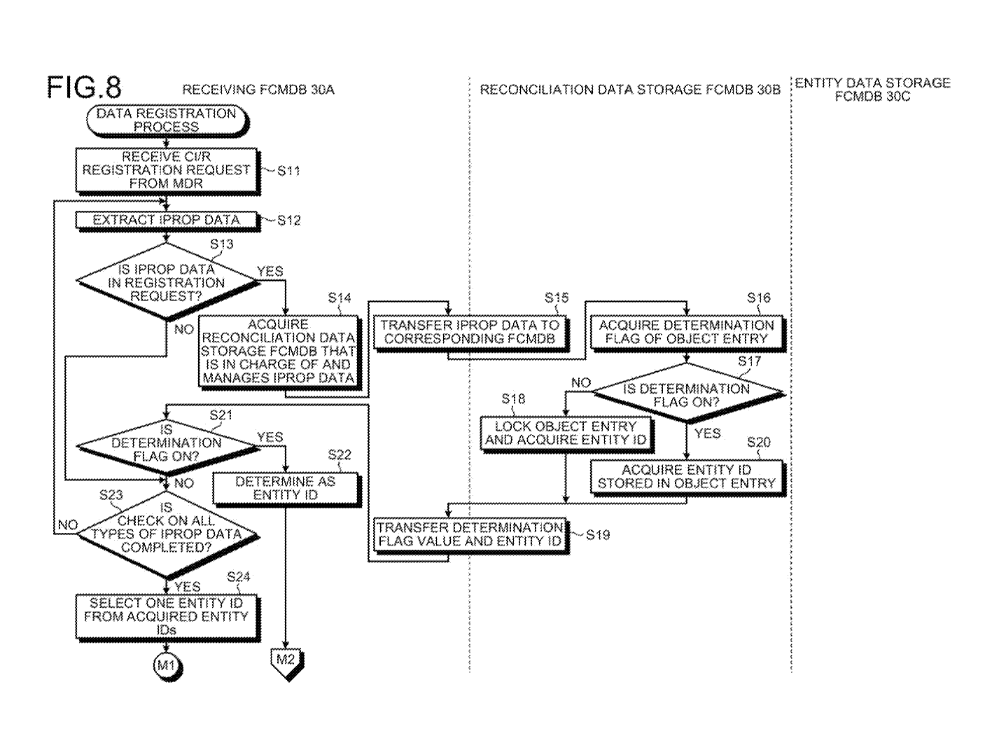

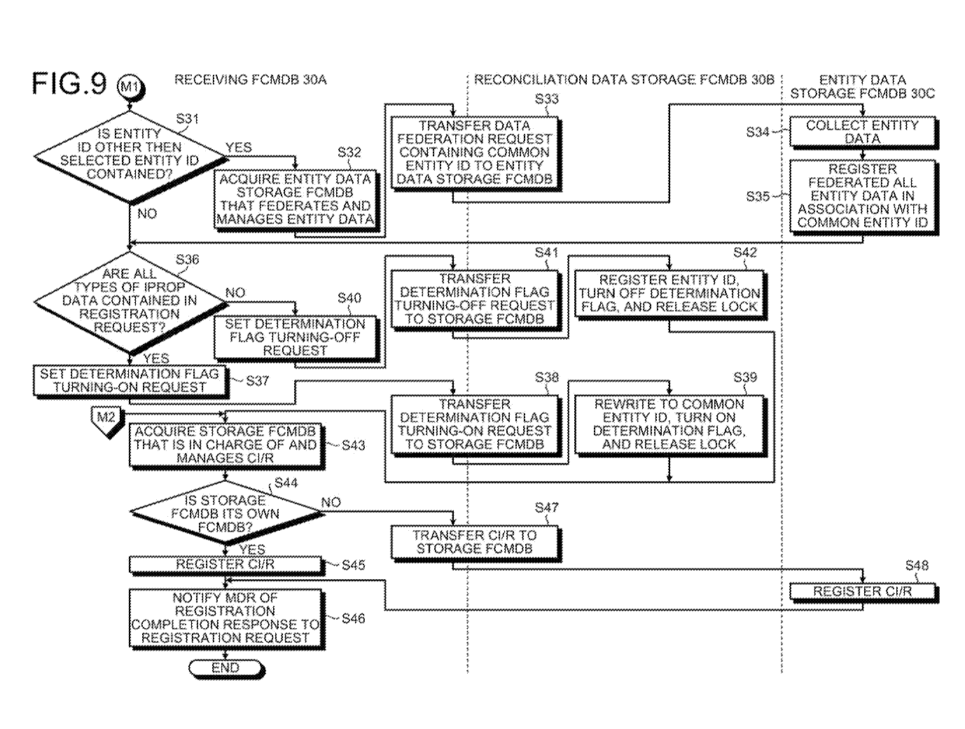

Operations of the distributed FCMDB system 1A will be described below. First, process operations involving the data registration process will be described, focusing on the receiving FCMDB 30A, reconciliation data storage FCMDBs 30B, and an entity data storage FCMDB 30C among FCMDBs 30 in the distributed FCMDB system. FIGS. 8 and 9 are flowcharts of process operations, involving the data registration process, of the distributed FCMDB system 1A. The receiving FCMDB 30A corresponds to the FCMDB 30 that receives a CI registration request from the MDR 20. The reconciliation data storage FCMDBs 30B correspond to the FCMDBs 30 that store the IPROP data regarding the same CI. Furthermore, the entity data storage FCMDB 30C corresponds to the FCMDB 30 that federates all the types of entity data regarding the same CI and stores the federated entity data.

The data registration service processor 31 in the receiving FCMDB 30A illustrated in FIG. 8 receives a CI/R registration request from the MDR 20 (step S11). The reconciliation processor 36 in the receiving FCMDB 30A extracts IPROP data from the registration request (step S12) and determines whether IPROP data is in the registration request via the IPROP determining unit 41 (step S13). At step S12, IPROP data is extracted. In order to prevent a deadlock, it is preferable that the order in which IPROP data is extracted be in a predetermined order, e.g., the IP address, the serial number, and the combination of the host name and the domain name in the order that they appear in this sentence.

When IPROP data is in the registration request (YES at step S13), the entity ID collector 42 in the reconciliation processor 36 computes IPROP data (the attribute name and the attribute value) via the data storage FCMDB search unit 33 using a hash function of the IPROP data (step S14). According to the hash values, the entity ID collector 42 acquires the FCMDB 30 that is in charge of and manages the IPROP data, i.e., acquires the reconciliation data storage FCMDB 30B (step S14). When the reconciliation data storage FCMDB 30B has been acquired, the entity ID collector 42 transfers the IPROP data to the reconciliation data storage FCMDB 30B via the FCMDB data communication unit 35 (step S15).

Upon receiving the IPROP data from the receiving FCMDB 30A, the reconciliation processor 36 in the reconciliation data storage FCMDB 30B acquires the determination flag of an object entry in which the IPROP data from the entity management table 45 is stored (step S16). The reconciliation controller 48 in the reconciliation processor 36 determines whether the determination flag of the object entry is on via the flag determining unit 47 (step S17).

When the determination flag is not on, i.e., the flag is off (No at step S17), the reconciliation controller 48 locks the object entry and acquires the entity ID of the IPROP data (step S18). Upon acquiring the entity ID, the reconciliation controller 48 registers the entity ID in association with the IPROP data in the object entry in the entity management table 45.

Upon acquiring the entity ID at step S18, the reconciliation controller 48 transfers the entity ID and the determination flag value (OFF) to the receiving FCMDB 30A via the FCMDB data communication unit 35 (step S19). When the determination flag in the object entry is on (YES at step S17), the reconciliation controller 48 acquires the entity ID that is stored in the object entry in the entity management table 45 (step S20). The reconciliation controller 48 then goes to step S19 in order to transfer the entity ID corresponding to the IPROP data and the determination flag value (ON) to the receiving FCMDB 30A.

According to the determination flag of each type of IPROP data that is acquired from the reconciliation data storage FCMDB 30B, the flag determining unit 47 in the receiving FCMDB 30A determines whether the determination flag is on (step S21). When the determination flag is on (YES at step S21), the reconciliation processor 36 determines that the entity ID that is acquired from the reconciliation data storage FCMDB 30B is for the IPROP data in the object entry (step S22) and goes to M2 in FIG. 9.

When the determination flag is not on, i.e., when the flag is off (NO at step S21), the reconciliation processor 36 in the receiving FCMDB 30A determines whether checking of all the types of IPROP data in the registration request is completed (step S23). When checking of all the types of IPROP data is completed (YES at step S23), the common entity adding unit 43 selects one entity ID from the entity IDs of all the types of IPROP data, each acquired at step S19 (step S24) and goes to M1 in FIG. 9. The common entity adding unit 43 selects an entity ID using the predetermined algorithm.

When checking of all the types of IPROP data is not completed (NO at step S23), the entity ID collector 42 goes to step S12 in order to extract unchecked IPROP data in the registration request.

At M1 in FIG. 9, the common entity adding unit 43 in the receiving FCMDB 30A determines whether there is an entity ID in the IPROP data, in the registration request, other than the entity ID that is selected at step S24 (step s31). When an entity ID other than the selected entity ID is in the IPROP data (YES at step S31), the common entity adding unit 43 determines, as a common entity ID, the entity ID that is selected at step S24. The reconciliation controller 48 then computes the common entity ID and calculates, using the hash function, the hash value of the common entity ID via the data storage FCMDB search unit 33 (step S32). According to the hash value of the common entity ID, the reconciliation controller 48 acquires the entity data storage FCMDB 30C that federates all the types of entity data regarding the same CI and stores the federated data (step S32).

The reconciliation controller 48 then notifies the entity data storage FCMDB 30C, which is acquired at step S32, of a federation collection request in order to collect all the types of entity data regarding the same CI from each FCMDB 30 (step S33). The federation collection request contains the common entity ID.

According to the federation collection request, the entity ID collector 42 in the entity data storage FCMDB 30C collects entity data regarding the same CI from each FCMDB 30 (step S34). When all types of entity data regarding the same CI have been collected, the reconciliation register 44 federates all the types of entity data and registers the federated entity data in association with the common entity ID in the local entity data manager 34 (step S35).

When an entity ID other than the selected entity ID is not contained in the IPROP data (NO at step S31), the reconciliation controller 48 in the receiving FCMDB 30A determines whether all the types of IPROP data are contained in the registration request (step S36).

When all the types of IPROP data are contained in the registration request (YES at step S36), the reconciliation controller 48 sets, via the flag setting unit 46, a flag turning-on request for turning on the determination flag corresponding to each type of IPROP data (step S37). When the flag turning-on request is set, the reconciliation controller 48 transfers, via the FCMDB data communication unit 35, the flag turning-on request and the common entity ID to the reconciliation data storage FCMDB 30B via the FCMDB data communication unit 35 (step S38).

The reconciliation register 44 in the reconciliation data storage FCMDB 30B acquires the flag turning-on request and the common entity ID. The reconciliation register 44 rewrites the entity ID in the entity management table 45 corresponding to the IPROP data to the common entity ID and registers the common entity ID (step S39). The reconciliation register 44 then turns on the determination flag in the entity management table 45, which corresponds to the IPROP data, and releases the lock of the object entry corresponding to the IPROP data (step S39).

When not all types of IPROP data are contained in the registration request (NO at step S36), the reconciliation controller 48 in the receiving FCMDB 30A sets, via the flag setting unit 46, a flag turning-off request for turning off the determination flag corresponding to each type of IPROP data (step S40). When the flag turning-off request is set, the reconciliation controller 48 transfers, via the FCMDB data communication unit 35, the flag turning-off request and the entity ID to the reconciliation data storage FCMDB 30B (step S41).

The reconciliation register 44 in the reconciliation data storage FCMDB 30B acquires the flag turning-off request and the entity ID. The reconciliation register 44 registers the entity ID in the entity management table 45 corresponding to the IPROP data (step S42). The reconciliation register 44 turns off the determination flags in the entity management table 45 corresponding to the IPROP data and releases the lock of the object entry corresponding to the IPROP data (step S42).

After step S39 or step S42, the data storage FCMDB search unit 33 in the receiving FCMDB 30A calculates a hash value by multiplying the entity ID, which is obtained at step S24, by the hash function (step S43). According to the hash value, the data storage FCMDB search unit 33 acquires the entity data storage FCMDB 30 in which entity data of the CI/R is stored (step S43).

The local entity data manager 34 determines whether the entity data storage FCMDB 30 is the receiving FCMDB 30A (step S44). When the entity data storage FCMDB 30 is the receiving FCMDB 30A (YES at step S44), the local entity data manager 34 registers the CI/R in association with the entity ID in the data management DB 34A (step S45). When registration of CI/R is completed, the data registration service processor 31 notifies the MDR 20 that issued the registration request of a registration complete response (step S46) and completes the process operations.

When the entity data storage FCMDB 30 is not the receiving FCMDB 30A (NO at step S44), the local entity data manager 34 transfers the CI/R to the entity data storage FCMDB 30C that is calculated at step S43 (step S47).

Upon receiving the CI/R, the local entity data manager 34 in the entity data storage FCMDB 30C registers the CI/R in association with the entity ID in the data management DB 34A (step S48) and goes to step S46.

The next step after registration of the entity data, which is federated at step S35, in the entity data storage FCMDB 30C is completed is also step S46.

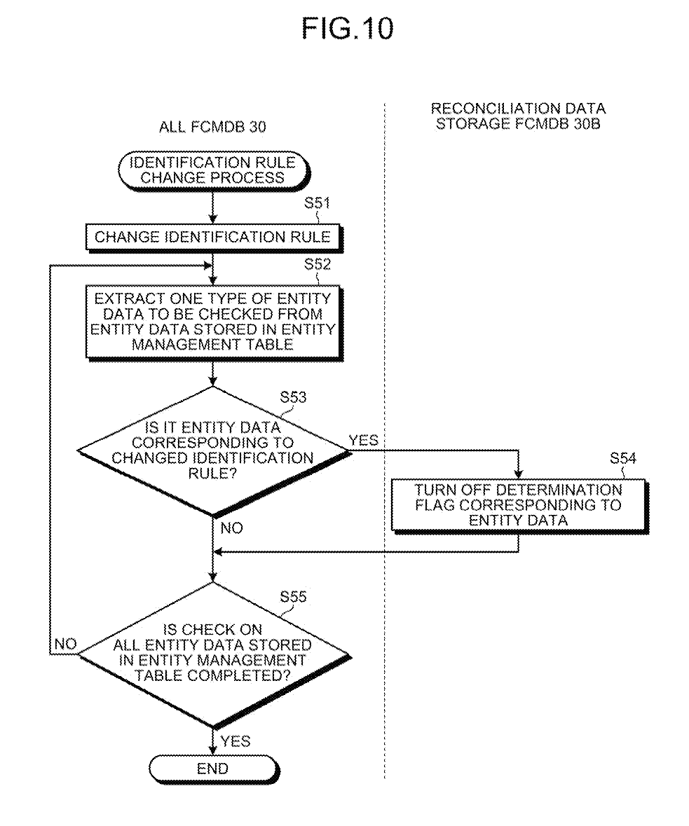

In the FCMDB 30, in principle, the pre-set identification rule, i.e., IPROP data, is not changed. However, the FCMDB 30 may change IPROP data according to a specifying operation of the FCMDB 30 or a specifying operation of the client terminal 5 to which the FCMDB 30 is connected via the network 4. When the FCMDB 30 changes the IPROP data, each determination flag that is turned on in the entity management table 45 of each FCMDB 30 is turned off. The case in which IPROP data is changed is, for example, a case in which a nickname is added in addition to three types of IPROP data (i.e., the IP address, the serial number, and a combination of the host name and the domain name) or a case in which a nickname is used instead of the combination of the host name and the domain name. FIG. 10 is a flowchart of process operations of the distributed FCMDB system 1A involving the identification rule change process.

As illustrated in FIG. 10, when the identification rule is changed (step S51), the reconciliation controller 48 in the FCMDB 30 extracts one type of entity data to be checked from the IPROP data that is stored in the entity management table 45 (step S52).

Upon extracting one type of entity data to be checked (step S51), the reconciliation controller 48 determines whether the extracted entity data is entity data corresponding to the changed identification rule (step S53).

When the extracted entity data is entity data corresponding to the changed identification rule (YES at step S53), the reconciliation controller 48 turns off the determination flag in the entity management table 45 corresponding to the entity data (step S54). Upon turning off the determination flag in the entity management table 45 corresponding to the entity data, the reconciliation controller 48 determines whether the check on all entity data in the entity management table is completed (step S55).

When the check on all entity data in the entity management table 45 is completed (YES at step S55), the reconciliation controller 48 ends the process operations illustrated in FIG. 10. When the check on all entity data in the entity management table 45 is not completed (NO at step S55), the reconciliation controller 48 goes to step S52 in order to extract unchecked entity data.

When the extracted entity data is not entity data corresponding to the changed identification rule (NO at step S55), the reconciliation controller 48 determines that the entity data has been checked and goes to step S52.

In the second embodiment, when entity IDs of all the types of IPROP data regarding the same Clare collected, one entity ID among those entity IDs is selected as a common entity ID and adds the common entity ID to all the types of IPROP data. Because the common entity ID corresponding to the same CI is added to the IPROP data, even when the IPROP data regarding the same CI is distributed, each FCMDB 30 can identify the CI according to the common entity ID.

In the second embodiment, the entity data that is associated with each type of IPROP data regarding the same CI is registered and managed in the FCMDB 30 that is searched using the hash value of the common entity ID of the same CI. Accordingly, the entity data regarding the same CI is federated, and the federated entity data is registered and managed in each FCMDB 30.

In the second embodiment, the IPROP data can be changed according to the specifying operation of the FCMDB 30 or the specifying operation of the client terminal 5.

In the second embodiment, when the registration request contains a combination of other registered IPROP data regarding the same CI including any one of the types of IPROP data regarding the same CI, the combination of IPROP data is recognized as the IPROP data regarding the same CI. For example, depending on the MDR 20, only a part of the IPROP data may be acquired; therefore, if IPROP data does not perfectly match but if even one type of IPROP data among the types of IPROP data matches, it is recognized as the same CI. By setting flexibility in the identification condition as described above, the process for recognizing the same CI can be carried out smoothly.

In the second embodiment, entity IDs of all types of IPROP data regarding the same Clare collected, an arbitrary entity ID is selected from the collected IDs using the predetermined algorithm, and the selected ID is set as the common entity ID corresponding to the same CI. This reduces the process load in selecting entity IDs corresponding to the same CI.

In the second embodiment, when adding of the common entity ID to all the types of IPROP data regarding the same CI is completed, the determination flags of all the types of IPROP data are turned on. The FCMDB 30 checks the determination flags of the IPROP data in the registration request and, when the determination flags are on, other extra processes for collecting entity IDs of other IPROP data are skipped. Accordingly, after adding the common entity ID to all the types of IPROP data regarding the same CI, a more high-speed process can be achieved.

In the second embodiment, by distributing and managing the IPROP data regarding the CI, the CI can be identified at high speed using the IPROP data while reducing the process load on the FCMDB 30 without it being necessary to increase the storage capacity.

Among the above-described processes according to the embodiments, the processes that are described as those automatically performed may be manually performed entirely or partially.

The components of each unit illustrated in the drawings are not necessarily required to be physically configured as illustrated in the drawings. In other words, the specific modes of separation or integration of the units are not limited to those illustrated in the drawings. The units may be configured in a way that they are entirely or partially separated or integrated functionally or physically on an arbitrary basis in accordance with various loads or how they are used.

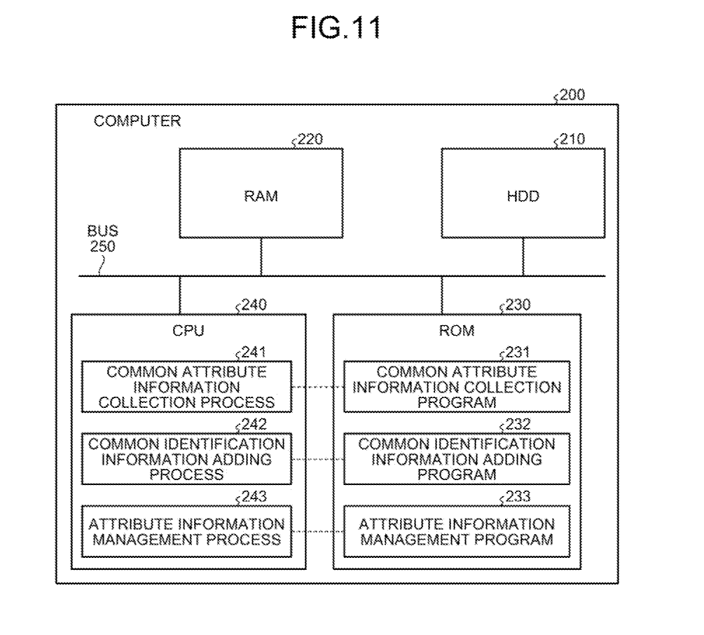

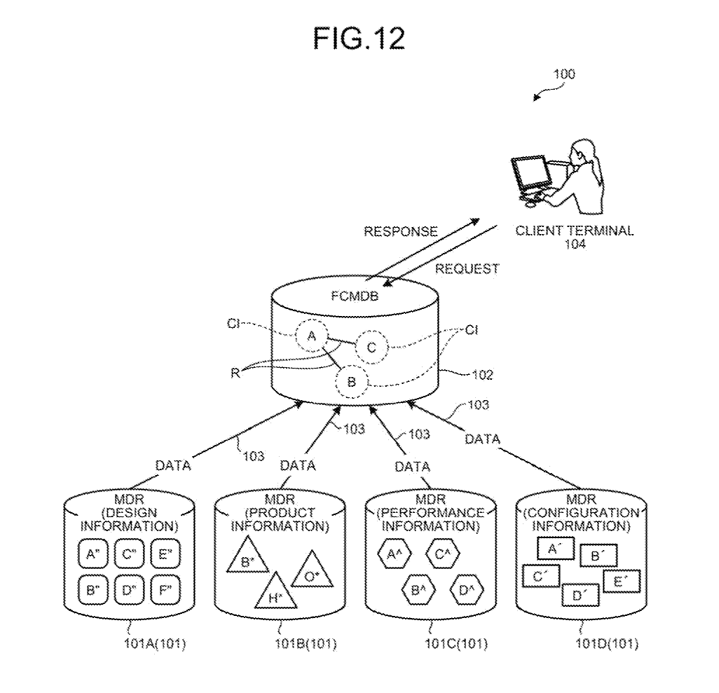

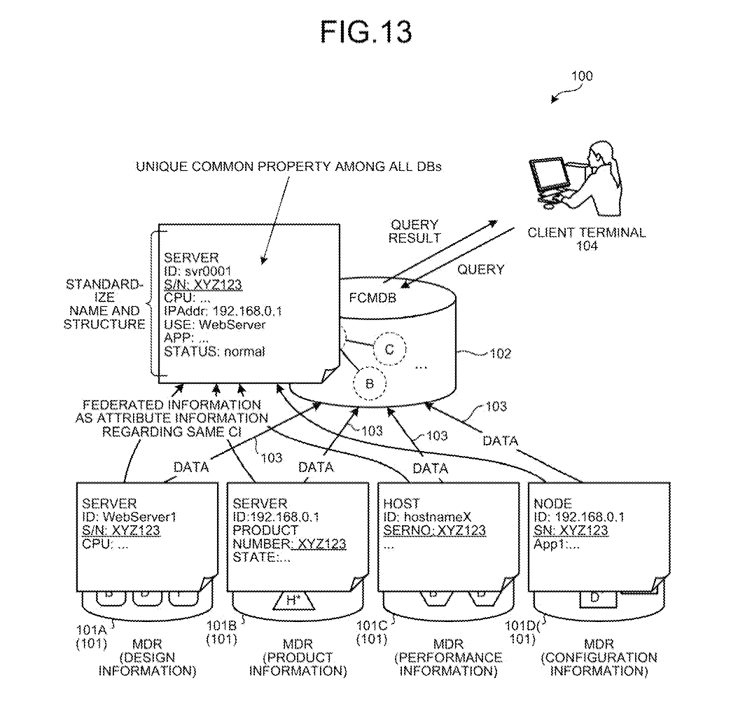

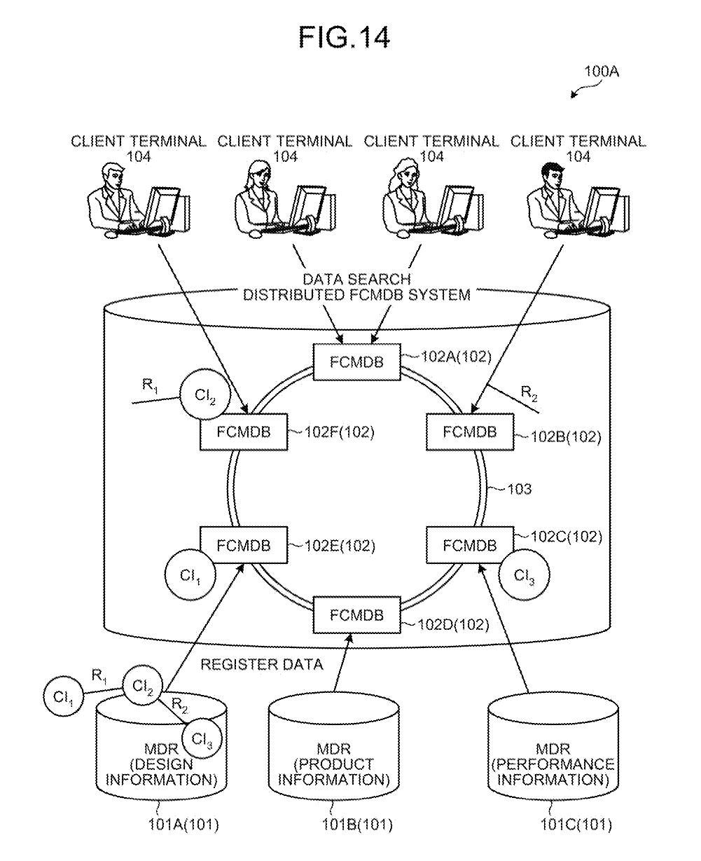

The processes that are described in the embodiments can be achieved by executing a prepared program using a computer. An example of a computer that executes a program that achieves the same functions as those of the embodiments will be described with reference to FIG. 11. FIG. 11 is a diagram of a computer that executes a distributed information management program.

As illustrated in FIG. 11, a computer 200 that serves as the distributed information management program includes a hard disk drive (HDD) 210, a RAM 220, a ROM 230, and a CPU 240 that are connected via a bus 250.

The distributed information management program is pre-stored in the ROM 230. In other words, a common attribute program information collecting program 231, a common identification information adding program 232, and an attribute information management program 233 are pre-stored in the ROM 230. The programs 231 to 233 may be separated or integrated appropriately in the same way as the components of the configuration information management system 1 illustrated in FIG. 1.

The CPU 240 reads the programs 231 to 233 from the ROM 230 and executes the programs 231 to 233. Accordingly, the programs 231 to 233 serve as a common attribute information collection process 241, a common identification information adding process 242, and an attribute information management process 243. The processes 241 to 243 correspond respectively to the identification information collector 11, the common identification information adding unit 12, and the attribute information manager 13 that are illustrated in FIG. 1.

As illustrated in FIG. 11, the HDD manages common attribute information regarding the same configuration item that is managed by the HDD 210 and also manages common attribute information regarding all federated predetermined types of attributes regarding the same configuration item that is managed by the HDD 210.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A configuration information management system, comprising:
a plurality of distributed information management devices that distribute and manage predetermined attribute types of common attribute information among attribute information of each configuration type regarding a configuration item, which is to be managed, from a plurality of configuration information control devices that manage the attribute information, the common attribute information being used to identify the configuration item,
wherein the distributed information management device includes
an identification information collector that collects identification information corresponding to the predetermined attribute types of common attribute information regarding the same configuration item;
a common identification information adding unit that, when the identification information corresponding to the predetermined attribute types of common attribute information regarding the same configuration item is collected, adds common identification information corresponding to the same configuration item to each of the predetermined attribute types of common attribute information regarding the same configuration item; and
a common attribute information manager that manages each of the predetermined types of common attribute information regarding the same configuration item in association with the common identification information that is added by the common identification information adding unit.

2. The configuration information management system according to claim 1, further comprising an attribute information register that, when the common identification information adding unit adds the common identification information corresponding to the same configuration item, federates the attribute information regarding the same configuration item and, distributes the federated attribute information regarding the same configuration item to the distributed information management devices, which relate to the common identification information regarding the same CI, and that registers the federated attribute information in the distribute information management devices.

3. The configuration information management system according to claim 1, further comprising a specifying unit that specifies the predetermined attribute types of common attribute information among the attribute information.

4. The configuration information management system according to claim 1, wherein
when a registration request for registering the configuration item that contains predetermined types of common attribute information regarding the same configuration item is detected and when the registration request contains a combination of other registered predetermined attribute types of common attribute information regarding the same configuration item including any one of the predetermined attribute types of common attribute information, the identification information collector collects identification information of the combination of the predetermined attribute types of common attribute information.

5. The configuration information management system according to claim 1, wherein the common identification information adding unit acquires identification information of each of the predetermined attribute types of common attribute information regarding the same configuration item, selects identification information of one of the predetermined attribute types of common attribute information among the acquired identification information, and sets the selected identification information as the common identification information corresponding to the same configuration item.

6. The configuration information management system according to claim 1, wherein the attribute information register includes
a distribution hash manager that manages information to be registered in each of the distributed information management devices, using a hash value; and
a distribution management search unit that calculates a hash value of the common attribute information according to a hash function of the common attribute information, and, according to the hash value, searches the distributed information management device in which the common attribute information is registered among the distributed information management devices.

7. The configuration information management system according to claim 1, wherein the distributed information management device further includes
a flag setting unit that, when adding the common identification information to the predetermined attribute types of common attribute information regarding the same configuration item is completed, turns on determination flags of the all the predetermined attribute types of common attribute information; and
a flag determining unit that, when the common attribute information is contained in the registration request, determines whether the determination flag corresponding to the common attribute information is on, and
when the flag determining unit does not determine that the determination flag corresponding to the common attribute information is on, the identification information collector starts a collection operation for collecting the identification information of another predetermined type of common attribute information regarding the same configuration item including the predetermined attribute types of common attribute information, and
when the flag determining unit determines that the determination flag corresponding to the common attribute information is on, the identification information collector skips the collection operation for collecting the identification information of another predetermined type of common attribute information regarding the same configuration item including the predetermined attribute types of common attribute information.

8. A distributed information management method for a plurality of distributed information management devices that distribute and manage predetermined attribute types of common attribute information among attribute information of each configuration type regarding a configuration item, which is to be managed, from a plurality of configuration information control devices that manage the attribute information, the common attribute information being used to identify the configuration item, the distributed information management method comprising:
collecting identification information corresponding to the predetermined attribute types of common attribute information regarding the same configuration item;
when the identification information corresponding to the predetermined attribute types of common attribute information regarding the same configuration item is collected, adding common identification information corresponding to the same configuration item to each of the predetermined attribute types of common attribute information regarding the same configuration item; and
managing each of the predetermined types of common attribute information regarding the same configuration item in association with the common identification information.

9. A distributed information management device, comprising:
an information manager that distributes and manages, in cooperation with distributed information management devices, predetermined attribute types of common attribute information among attribute information of each configuration type regarding a configuration item, which is to be managed, from a plurality of configuration information control devices that manage the attribute information, the common attribute information being used to identify the configuration item;
an identification information collector that collects identification information corresponding to the predetermined attribute types of common attribute information regarding the same configuration item;
a common identification information adding unit that, when the identification information corresponding to the predetermined attribute types of common attribute information regarding the same configuration item is collected, adds common identification information corresponding to the same configuration item to each of the predetermined attribute types of common attribute information regarding the same configuration item; and
a common attribute information manager that manages each of the predetermined types of common attribute information regarding the same configuration item in association with the common identification information that is added by the common identification information adding unit.

10. A computer-readable, non-transitory medium storing a distributed information management program causing a computer to execute a process comprising:
distributing and managing, in cooperation with distributed information management devices, predetermined attribute types of common attribute information among attribute information of each configuration type regarding a configuration item, which is to be managed, from a plurality of configuration information control devices that manage the attribute information, the common attribute information being used to identify the configuration item;
collecting identification information corresponding to the predetermined attribute types of common attribute information regarding the same configuration item;
adding, when the identification information corresponding to the predetermined attribute types of common attribute information regarding the same configuration item is collected, common identification information corresponding to the same configuration item to each of the predetermined attribute types of common attribute information regarding the same configuration item; and
managing each of the predetermined types of common attribute information regarding the same configuration item in association with the common identification information that is added at the adding.
